(19) United States
(12) Patent Application Publication
(10) Pub. No.: US 2005/0205730 A1
(43) Pub. Date: Sep. 22, 2005

(54) Configurable mounting bracket

(76) Inventor: Jeffrey D. Carnevali, Seattle, WA (US)

Correspondence Address: Charles J. Rupnick, PO Box 46752, Seattle, WA, 98146, US

(21) Appl. No.: 10/836,494

(22) Filed: Apr. 30, 2004

Related U.S. Application Data
(63) Continuation-in-part of application No. 10/802,408, filed on Mar. 17, 2004.

(51) Int. Cl. F16L 11/118

(52) U.S. Cl. 248/163.1

(57) ABSTRACT

A multiply configurable tripodal mounting bracket having multiple permanently bendable tubular support legs each having an interior tubular cavity substantially filled with a solidified filler material, means for clamping a first end of each tubular support leg in a fixed tripodal arrangement, and means for securing a second end of each tubular support leg relative to an external surface, such as a vehicle floorboard. Each tubular support leg optionally including an elongated stiffener within the interior tubular cavity and embedded in the solidified filler material. The mounting bracket also includes means for fixing an external device, such as a portable desk or laptop computer, to the clamp portion of the bracket.

This application is a Continuation-in-part and claims the benefit of co-pending parent patent application Ser. No. 10/802,408 (Attorney Docket No. NPI-023) entitled, “CONFIGURABLE MOUNTING BRACKET,” filed in the name of Jeffrey D. Carnevali on Mar. 17, 2004, which is incorporated herein by reference.

### FIELD OF THE INVENTION

The present invention relates to a configurable mounting bracket, and in particular to a vehicle-mountable multiply configurable tripod for mounting a portable desktop, a computer or the like.

### BACKGROUND OF THE INVENTION

In today's business world many people need to carry a laptop computer to conduct business on the road or even while vacationing. In general, our automobiles and other vehicles were designed for carrying passengers, rather than laptop computers or portable desks. As a result, the laptop or desk is dropped into the passenger seat where it is prey to sudden starts and stops and is accessed only with difficulty by the driver leaning over the passenger seat. Such access is impossible while driving without courting an accident. Mounting brackets suitable for supporting a portable desk or laptop computer are generally well-known for permanent installation in an automobile or other vehicle. Some of these known vehicle-mountable brackets are configurable to fit different makes and models of vehicle. All but a few require cutting of the vehicle to fit the mounting bracket, trimming or cutting the bracket to fit, or at least drilling the vehicle to accept fasteners for securing the bracket. Furthermore, these known vehicle-mountable brackets are typically limited to presenting their mounting surfaces, and by extension the laptop computers or portable desks, in a predetermined single position relative to the vehicle driver or other user.

### SUMMARY OF THE INVENTION

The present invention is a vehicle-mountable multiply configurable tripodal mounting bracket that overcomes limitations of the prior art for securely mounting a portable desktop, a computer or the like. Accordingly, the mounting bracket of the invention includes multiple permanently bendable cylindrical tubular metal support legs each filled with a solid filler material and each having a first lengthwise end portion fitted into a clamp having a combination rigid mounting platform, and a second lengthwise end portion opposite from the respective first lengthwise end portion, each of the respective second tubular support leg lengthwise end portions being fitted with a shoe that is structured with means for securing the respective second end portion relative to an external surface using a structure configured either for being permanently fixed to the external surface with a mechanical fastener, or configured for resisting slipping relative to the external surface.

The clamp portion of the combination clamp and rigid mounting platform includes an outer female collar forming therein a truncated funnel-shaped cavity having multiple part cylindrical relief grooves formed at uniformly spaced intervals around a conical inside wall surface thereof, the multiple part cylindrical relief grooves are sized for nesting of the first lengthwise end portion of one of the cylindrical tubular metal support legs, one of the part cylindrical relief grooves being formed for each of the cylindrical tubular metal support legs which, according to another aspect of the invention, may number three. A truncated cone-shaped inner male wedge has multiple part cylindrical relief grooves formed at uniformly spaced intervals around a conical outside wall surface thereof, the multiple part cylindrical relief grooves are sized for nesting of the lengthwise end portion of one of the cylindrical metal rods, one of the wedge's part cylindrical relief grooves being formed for each of the permanently bendable metal rods with the relief grooves being spaced around the outside conical wall surface in a complementary configuration with respective ones of the relief grooves formed on the collar inside wall surface for forming multiple pairs of complementary part cylindrical relief grooves, with one of the pairs being provided for each of the cylindrical metal support rods. The wedge is sized relative to the collar such that a cylindrical inside diameter formed by each of the pairs of complementary part cylindrical relief grooves is smaller than an outer diameter of the respective cylindrical tubular metal support legs end portions when nested therein, whereby the outer diameters of the respective cylindrical tubular metal support leg end portions are securely clamped between the respective pairs of complementary part cylindrical relief grooves. The clamp portion also includes means for urging the male wedge deep into the cup-shaped female collar with each of the leg lengthwise end portions securely captured between one of the pairs of complementary part cylindrical relief grooves.

According to another aspect of the present invention, the rigid mounting platform portion of the combination clamp and rigid mounting platform is formed of an outer base surface of the outer female collar opposite from an inner floor portion of the truncated funnel-shaped cavity thereof. The rigid mounting platform portion is structured with means for permanently attaching an external device thereto, either directly or through an intermediary mounting device.

According to another aspect of the present invention, the mounting bracket of the present invention includes an elastically flexible plastic tubular sheath covering each of the permanently bendable cylindrical tubular metal support legs and optionally secured at opposite ends to the clamp and shoe at the ends of the support legs.

According to another aspect of the present invention, one or more of the cylindrical tubular metal support legs is provided with an elongated internal stiffener that optionally extends the entire length of the filled support leg from the first lengthwise end portion to the opposite second lengthwise end portion. The stiffener is, by example and without limitation, a permanently bendable metal rod, multiple permanently bendable metal wires, a cable formed of multiple twisted metal wires, or an smaller diameter inner tube, and is embedded in the solidified material filling an interior tubular cavity of each of the cylindrical tubular metal support legs.

According to another aspect of the present invention, a method is provided for manufacturing a vehicle mounting bracket, the method including sizing a length of each of a quantity of elongated tubular members of a permanently bendable tubular material, each of the elongated tubular members having first and second end portions with a tubular interior cavity therebetween. One or more of the plurality of elongated tubular members is shaped into a configuration useful for operating in concert with others of the plurality of elongated tubular members for supporting a rigid mounting platform at the colocated first ends of the plurality of elongated tubular members. The tubular interior cavity of one or more of the elongated tubular members is substantially filled with a hardenable material, for example, a hardenable epoxy. The first ends of the elongated tubular members are substantially colocated and the colocated first ends of the plurality of elongated tubular members are fixed relative to one another. A rigid mounting platform is supported at the colocated first ends of the elongated tubular members.

According to another aspect of the method of the invention, an elongated stiffener of a permanently bendable material is installed within the tubular interior cavity of one or more of the plurality of elongated tubular members and embedded in the solidified filler material.

According to another aspect of the method of the invention, a means is provided for securing the second end portions of the elongated tubular members relative to an external surface that is installed on the second end portions of the elongated tubular members. The securing means are, by example and without limitation, either a shoe having a slot for a mechanical fastener, or a non-slip tip such as a type known use with canes and crutches.

According to another aspect of the invention, a method is provided for forming and filling the elongated tubular members and joining them together into a vehicle mounting bracket of the type disclosed herein.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the invention embodied as a mounting bracket apparatus having a trio of permanently bendable cylindrical solid metal support rods extended between a combination clamp and rigid mounting platform and a shoe that is structured with means for securing the mounting bracket relative to an external surface, such as a floor of an automobile or other vehicle;

FIGS. 2 and 3 are respective top and bottom perspective exploded views of the combination clamp and rigid mounting platform;

FIG. 4 illustrates the mounting bracket apparatus of the invention having the plurality of bendable metal support rods permanently formed in a tripod stance that configures them substantially in a right angle triangle while supporting a portable desk or laptop computer on a platform;

FIG. 5 illustrates the mounting bracket apparatus of the invention with one shoe embodied as a plastic or rubber boot or cap that cannot slip relative to a floor or other external surface, FIG. 5 also illustrates the permanently bendable metal support rods each covered in a flexible plastic sheath sized to slip over the metal support rods;

FIG. 6 illustrates the mounting bracket apparatus of the invention having a plurality of filled bendable tubular metal support legs substituted for the permanently bendable metal support rods;

FIG. 7 illustrates the mounting bracket apparatus of the invention having the plurality of filled bendable tubular metal support legs internally reinforced with bendable metal interior stiffener rods;

FIG. 8 illustrates one alternative embodiment of the present invention having a plurality of relatively lighter gage permanently bendable interior support wires substituted for one or more of the permanently bendable interior stiffener rods illustrated in FIG. 7;

FIG. 9 illustrates another alternative embodiment of the present invention having a twisted cable substituted for one or more of the permanently bendable interior stiffener rods illustrated in FIG. 7; and

FIG. 10 illustrates another alternative embodiment of the present invention having an inner stiffener tube that is substituted for one or more of the permanently bendable interior stiffener rods illustrated in FIG. 7.

### DETAILED DESCRIPTION OF PREFERRED EMBODIMENT

In the Figures, like numerals indicate like elements.

The present invention is a vehicle mounting bracket embodied, by example and without limitation, as a rigidly positionable vehicle-mountable multiply configurable tripodal mounting bracket for securely and fixedly mounting a portable desktop, a computer or the like, the mounting bracket having a plurality of permanently bendable cylindrical solid metal support rods each having a first lengthwise end portion fitted into a combination clamp and rigid mounting platform and a second lengthwise end portion opposite from the respective first lengthwise end portion, each of the respective second rod lengthwise end portions being fitted with a shoe that is structured with means for securing the respective second end portion relative to an external surface using a structure configured either for being permanently fixed to the external surface with a mechanical fastener, or configured for resisting slipping relative to the external surface.

The clamp portion being formed of the combination clamp and rigid mounting platform being, by example and without limitation, an outer female collar forming therein a truncated funnel-shaped cavity having formed at uniformly spaced intervals around a conical inside wall surface thereof a plurality of part cylindrical relief grooves that are sized for nesting of the first lengthwise end portion of one of the cylindrical metal rods, one of the plurality of part cylindrical relief grooves being formed for each of the plurality of cylindrical metal rods which may number three; a truncated cone-shaped inner male wedge having at uniformly spaced intervals around a conical outside wall surface thereof a plurality of part cylindrical relief grooves that are sized for nesting of the lengthwise end portion of one of the cylindrical metal rods, one of the wedge's plurality of part cylindrical relief grooves being formed for each of the plurality of permanently bendable metal rods with the relief grooves being spaced around the outside conical wall surface in a complementary configuration with respective ones of the relief grooves formed on the collar inside wall surface for forming a plurality of pairs of complementary part cylindrical relief grooves with one of the pairs being provided for each of the cylindrical metal support rods, the wedge being sized relative to the collar such that a cylindrical inside diameter formed by each of the plurality of pairs of complementary part cylindrical relief grooves is smaller than an outer diameter of the respective cylindrical metal support rod end portions when nested therein, whereby the outer diameters of the respective cylindrical metal support rod end portions are securely clamped between the respective pairs of complementary part cylindrical relief grooves; and means for urging the male wedge deep into the cup-shaped female collar with each of the rod lengthwise end portions securely captured between one of the pairs of complementary part cylindrical relief grooves.

The rigid mounting platform portion of the combination clamp and rigid mounting platform being, by example and without limitation, formed of an outer base surface of the outer female collar opposite from an inner floor portion of the truncated funnel-shaped cavity thereof, the rigid mounting platform portion being structured with means for permanently attaching an external device thereto, either directly or through an intermediary mounting device.

According to one embodiment of the invention, the mounting bracket of the present invention includes an elastically flexible plastic tubular sheath covering each of the permanently bendable cylindrical metal support rods and optionally secured at opposite ends to the clamp and shoe at the ends of the metal support rods.

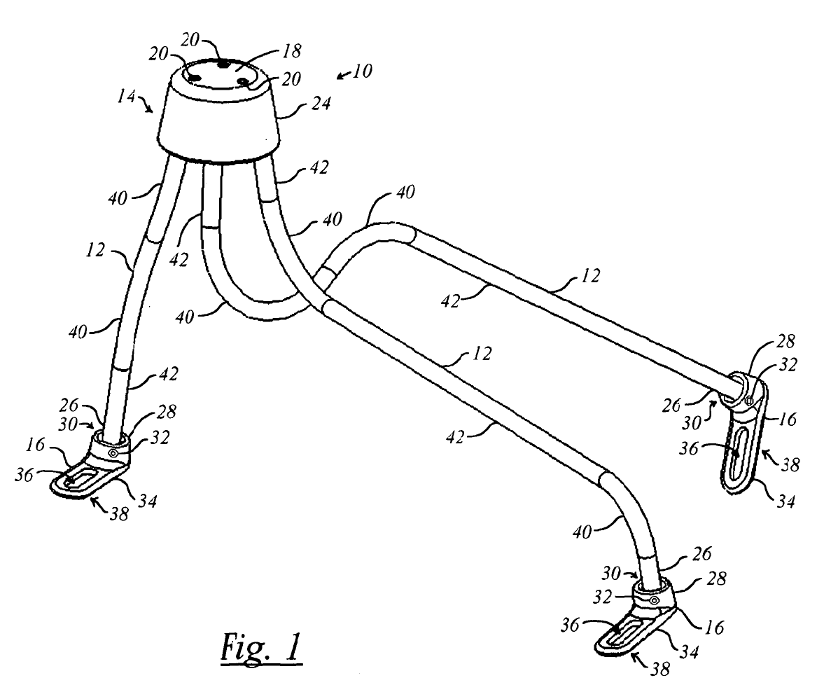

FIG. 1 illustrates the invention embodied as a mounting bracket apparatus 10 formed at its core by a trio of permanently bendable elongated cylindrical solid metal support rods 12 that each extend between a combination clamp mechanism and rigid mounting platform 14 and a shoe mechanism 16 that is structured with means for securing the mounting bracket 10 relative to an external surface, such as a floor of an automobile or other vehicle. The support rods 12 are legs either all of a single length, or of two different lengths, or of all different lengths, as appropriate to a particular application. It is intended that the lengths be set during manufacturing by shortening from a standard length. However, the lengths may all be identical at the time of shipment from the factory and later modified as appropriate by an installer or end user. The illustrations showing the support rods 12 of different lengths is not intended to operate as an absolute limitation on the scope of the invention. The support rods 12 are sized to substantially rigidly support the weight of a portable desk or laptop computer on a platform, for example, of the type described by Carnevali, the inventor of the present invention, in U.S. Pat. No. 6,585,212, issued Jul. 1, 2003, entitled “QUICK RELEASE ELECTRONICS PLATFORM,” which is incorporated herein by reference. By example and without limitation, the support rods 12 are embodied as cylindrical rods of a permanently bendable aluminum or aluminum alloy with a substantially constant diameter of about ½ inch, but at least in the range of about ¼ inch or ⅜ inch to about 1 inch. The permanently bendable cylindrical support rods 12 are alternatively realized in steel, copper, permanently bendable copper alloys or another permanently bendable metal or rigid plastic material without limiting the practice of the invention.

As discussed in detail herein, all of the support rods 12 are securely fixed to the combination clamp and rigid mounting platform 14 which includes a rigid mounting platform portion 18 embodied as a substantially planar surface sized to support a portable desk or laptop computer on a platform. Furthermore, the mounting platform portion 18, or another part of the combination clamp and mounting platform 14, is structured with means for permanently attaching an external device thereto, such as a portable desk or laptop computer on a platform, either directly or through an intermediary mounting device, for example, of the type described by Carnevali, the inventor of the present invention, in U.S. Pat. No. 5,845,885, issued Dec. 8, 1998, entitled “UNIVERSALLY POSITIONABLE MOUNTING DEVICE,” which is incorporated herein by reference. By example and without limitation, the means for permanently attaching an external device to the mounting platform portion 18 is embodied in one or more threaded fasteners 20 passed through suitable clearance through-holes 22 distributed on around the mounting platform portion 18, as discussed in detail herein.

The mounting platform portion 18, as illustrated in the Figures, is embodied at one end of a clamp portion 24 of the combination clamp and rigid mounting platform 14, which is discussed in detail herein.

Each of the support rods 12 has a short lengthwise end portion 26 opposite from the combination clamp and mounting platform 14, each of which is fitted with one of the shoes 16 that are structured with means for securing the respective rod end portion 26 relative to an external surface. Each of the shoes 16 includes means for gripping the rod end portion 26. By example and without limitation, each of the shoes 16 is provided with an ankle portion 28 having an aperture 30 sized to admit the rod end portion 26 and means to grip it, such as a set screw 32 applied to a threaded aperture (also indicated at 32). Alternatively, the shoe 16 is welded, soldered or brazed to the rod end portion 26. By example and without limitation, as illustrated in FIG. 1, one or more of the shoes 16 is formed of a substantially rigid material, e.g., metal or hard plastic, and is structured with a foot portion 34 that is structured for being permanently fixed to the external surface with a mechanical fastener. For example, the foot portion 34 of each shoe 16 is structured with an aperture or slot 36 formed therethrough through which a mechanical fastener, such as a screw or bolt, can pass for securing the shoe 16 to the external surface, such a floor board of an automobile or other vehicle. Each of the support rods 12 is bendable by hand to orient a sole 38 of the foot 34 into substantially parallel alignment with the external surface for more securely fixing the shoe 16 thereto. By example and without limitation, the bendable support rods 12 are illustrated as having different bent and substantially straight portions 40, 42, respectively.

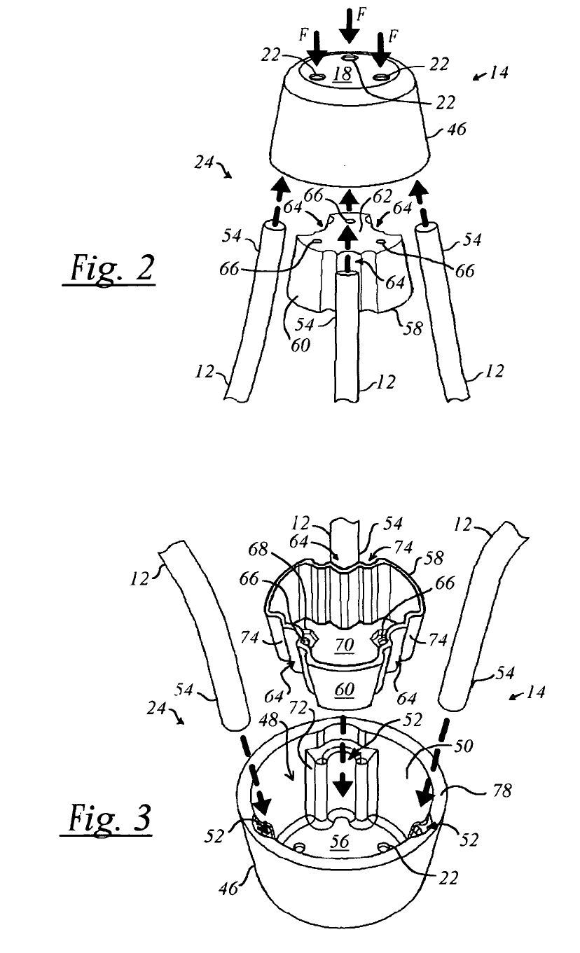

FIGS. 2 and 3 are exploded views of the combination clamp and rigid mounting platform 14 from different views, each showing assembly of the clamp portion 24 with the plurality of bendable support rods 12. Accordingly, FIG. 2 illustrates by example and without limitation one embodiment the combination clamp and rigid mounting platform 14 showing the one or more through-holes 22 distributed on around the mounting platform portion 18.

The mounting platform portion 18 is embodied at one end of the clamp portion 24 which is illustrated in FIG. 3, by example and without limitation, as being formed of an outer cup-shaped female collar 46 embodying a truncated funnel-shaped interior cavity 48 having a substantially conical inside wall surface 50. The collar interior cavity 48 is formed with a plurality of part cylindrical relief grooves 52 at intervals uniformly spaced around the conical inside wall surface 50, one of the relief grooves being provided for each of the plurality of support rods 12 which may number three according to one embodiment of the invention. The relief grooves 52 serve to secure the support rods 12 in fixed alignment with the collar 46, whereby the mounting bracket 10 is stabilized relative to an external surface to which it is secured. The relief grooves 52 are canted inwardly toward one another generally following the conical inside wall surface 50 of the interior cavity 48 in which they are formed. The plurality of part cylindrical relief grooves 52 are formed having substantially the same diameter as the cylindrical metal support rods 12 and are therefore sized for nesting of a short lengthwise end portion 54 of one of the cylindrical metal rods 12. The funnel-shaped interior cavity 48 of the collar 46 is truncated by an inner floor 56 having formed therethrough the plurality of fastener clearance through-holes 22 that are distributed on around the mounting platform portion 18. The inner floor 56 of the collar 46 operates as a stop for the support rods 12 for fixing the support rods 12 lengthwise relative to the collar 46.

The clamp portion 24 of the combination clamp and rigid mounting platform 14 also includes a means for securing the plurality of support rods 12 relative to the part cylindrical relief grooves 52 of the collar 46. By example and without limitation, the means for securing the plurality of support rods 12 relative to the collar's part cylindrical relief grooves 52 is embodied in a inner male wedge 58 having a hollow truncated cone-shape that is structured to fit inside the truncated funnel-shaped interior cavity 48 of the collar 46. Accordingly, a conical outside wall surface 60 of the wedge 58 is sized and shaped to nest substantially concentrically with the collar's funnel-shaped interior cavity 48 with the wedge's conical outside wall surface 60 stopping against the collar's conical inside wall surface 50. Alternatively, the wedge 58 is sized to nest within the collar 46 with its truncated end surface 62 stopping against the collar truncated inner floor 56.

According to one embodiment of the invention, the outside wall surface 60 of the wedge 58 is formed with a plurality of part cylindrical relief grooves 64 that are uniformly spaced at intervals that correspond to the plurality of part cylindrical relief grooves 52 around the collar inside wall surface 50. Each of the plurality of part cylindrical relief grooves 64 is sized for nesting of the short lengthwise end portion 54 of one of the cylindrical metal rods 12. One of the plurality of part cylindrical relief grooves 64 is formed for each of the plurality of permanently bendable metal support rods 12 in a complementary configuration with the relief grooves 52 on the collar inside wall surface 50 for forming a plurality of lengthwise cylindrical cavities between corresponding pairs of complementary part cylindrical relief grooves 52, 64, with one of the pairs being provided for each of the cylindrical metal support rods 12. According to one embodiment of the invention, the pairs of complementary part cylindrical relief grooves 52, 64 remain slightly spaced apart when the support rods 12 are clamped therebetween so that secure clamping of the support rods 12 is thereby assured.

Furthermore, the wedge 58 is sized relative to the collar 46 such that a substantially cylindrical diameter formed by each of the plurality of pairs of complementary part cylindrical relief grooves 52, 64 is smaller than an outer diameter of the respective short lengthwise cylindrical support rod end portions 54 nested therein during assembly. The outer diameters of the respective cylindrical support rod end portions 54 are thereby securely clamped between the respective pairs of complementary part cylindrical relief grooves 52, 64 when the male wedge 58 is securely nested within the female collar 46.

Accordingly, means are provided for urging the male wedge 58 deep into the cup-shaped female collar 46 with each of the rod lengthwise end portions 54 securely captured between one of the plurality of pairs of complementary part cylindrical relief grooves 52, 64. By example and without limitation, the fastener clearance through-holes 22 are optionally aligned with threaded or clearance holes 66 through the truncated end surface 62 of the wedge 58. Threading of fasteners F between the collar 46 and wedge 58 draws the wedge 58 into the collar's funnel-shaped cavity 48, and tightening the fasteners F secures the rod lengthwise end portions 54 between the pairs of complementary part cylindrical relief grooves 52, 64. When the holes 66 are clearance holes for fasteners, a fastener locking relief 68, e.g., sized for a square or hex nut, is optionally formed on an inside surface 70 of the wedge 58 opposite from the truncated end surface 62, which eases assembly of the mounting bracket apparatus 10.

According to one embodiment of the invention, the part cylindrical relief grooves 52 are optionally formed in the collar 46 within internal bosses 72 formed on the inside wall surface 50. These bosses 72 increase the wall strength and stiffness at the attachment points of the support rods 12, i.e., at the part cylindrical relief grooves 52 of the collar 46. The part cylindrical relief grooves 64 are formed within different reliefs 74 formed in the conical outside wall surface 60 of the wedge 58. These reliefs 74 are complementary to the bosses 72 on the collar inside wall surface 50 and are sized to nest with the bosses 72. The reliefs 74 increase the wall strength and stiffness at the attachment points of the support rods 12, i.e., at the part cylindrical relief grooves 64 of the wedge 58. Furthermore, the bosses 72 and complementary reliefs 74 nested therein operate to maintain relative rotational stability between the collar 46 and wedge 58. In other words, the reliefs 74 nest within the collar's cavity 48 between the bosses 72 and keep the wedge 58 from rotating or twisting when external loads are applied to the rigid mounting platform portion 18, as by loads applied to the portable desk or laptop computer supported by the mounting bracket apparatus 10 of the invention.

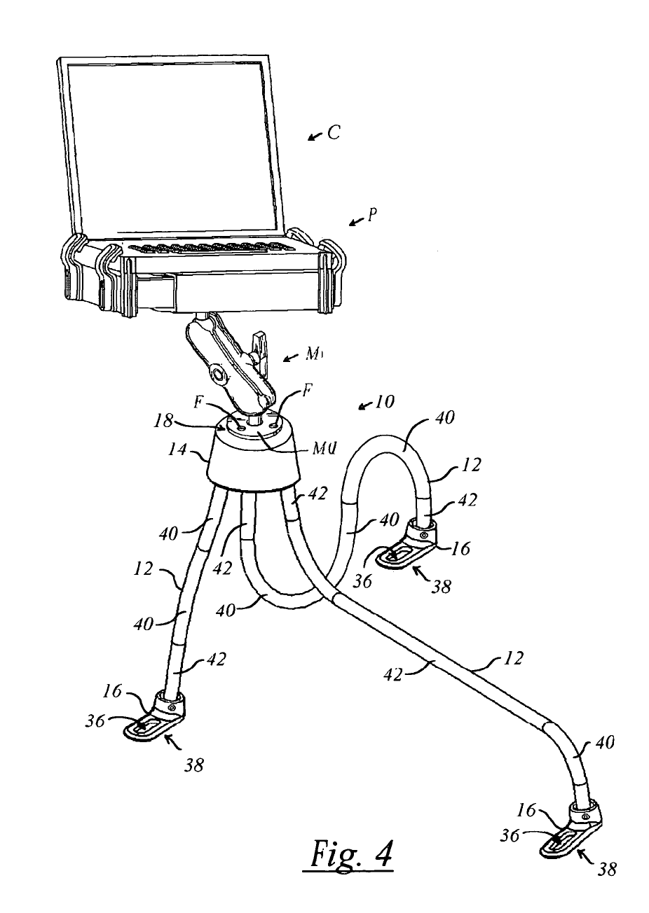

FIG. 4 illustrates the mounting bracket apparatus 10 of the invention having the plurality of bendable metal support rods 12 permanently formed in a tripod stance that configures them substantially in a right angle triangle with two of the three of the shoes 16 (the leftmost two) oriented with their respective soles 38 oriented substantially horizontally, while a third of the three shoes 16 (shown on the far right) tilted for orienting its sole 38 at an angle to the horizontal. The plurality of bendable metal support rods 12 are thus permanently bent to orient the soles 38 of the leftmost two shoes 16 for attachment to a substantially horizontal mounting surface such as the floorboard of an automobile at the two attachment points along one side of one of the front seats adjacent to the door, while orienting the sole 38 of the rightmost shoe 16 to a non-horizontal mounting surface such as the tilted floorboard of the automobile at the seat attachment point bordering the driveline hump in the middle of the automobile. The mounting bracket apparatus 10 of the invention is thus installed in the automobile at the attachment points of, for example, the driver or passenger front seat, without need of any drilling or cutting of the automobile's structure, by simply removing three of the bolt holding the seat to the floorboard, bending the support rods 12 and optionally rotating the shoes 16 to align the shoe soles 38 with the floorboard and present the slots 36 over the holes in the floorboard for three of the bolt holding the seat, and re-installing the three bolts, thereby securing the shoes 16 and the mounting bracket apparatus 10 to the floorboard along with the seat. This operation presents the rigid mounting platform portion 18 of the combination clamp and rigid mounting platform 14 in a position, for example, ahead of the front passenger seat adjacent to the hump and above the seat bottom cushion and any center console that may be present in the automobile. The mounting platform 18 is thus positioned for presenting a portable desk or laptop computer on a platform (shown) in a position convenient to the automobile's driver. In the example of FIG. 4, the mounting platform 18 is configured for attachment of a universal positioning device M, by example and without limitation, of the type described by Carnevali in U.S. Pat. No. 5,845,885, which is incorporated herein by reference.

Optionally, the base M1 of the universal positioning device M is selected such that the fasteners F that draw the wedge 58 into the funnel-shaped cavity 48 of the collar 46 also secure the positioning device base M1 to the apparatus mounting platform 18, although this is merely a convenience of the collar design and selection of the positioning device base M1. The mounting bracket apparatus 10 of the invention is thus an effective device for presenting a portable desk or laptop computer C when utilized with a platform P, for example, of the type described by Camevali in U.S. Pat. No. 6,585,212, which is incorporated herein by reference, which is configured with a resiliently compressible ball-shaped coupler of the type described by Carnevali in U.S. Pat. No. 5,845,885 for use with the universal positioning device M. After the mounting bracket apparatus 10 of the invention is secured to the automobile floorboard with the universal positioning device M mounted on the mounting platform 18, the computer C is maneuvered on the universal positioning device M to present the keyboard and display screen for convenient access by the driver or other user. Of course, the metal support legs 12 are bendable into countless other configurations for mounting of the mounting bracket apparatus 10 of the invention in other positions in the automobile, or for mounting in different vehicles such as RVs, all terrain vehicles (ATVs), boats, airplanes, or other vehicles wherein a portable desk, laptop computer or other after-market device would be useful.

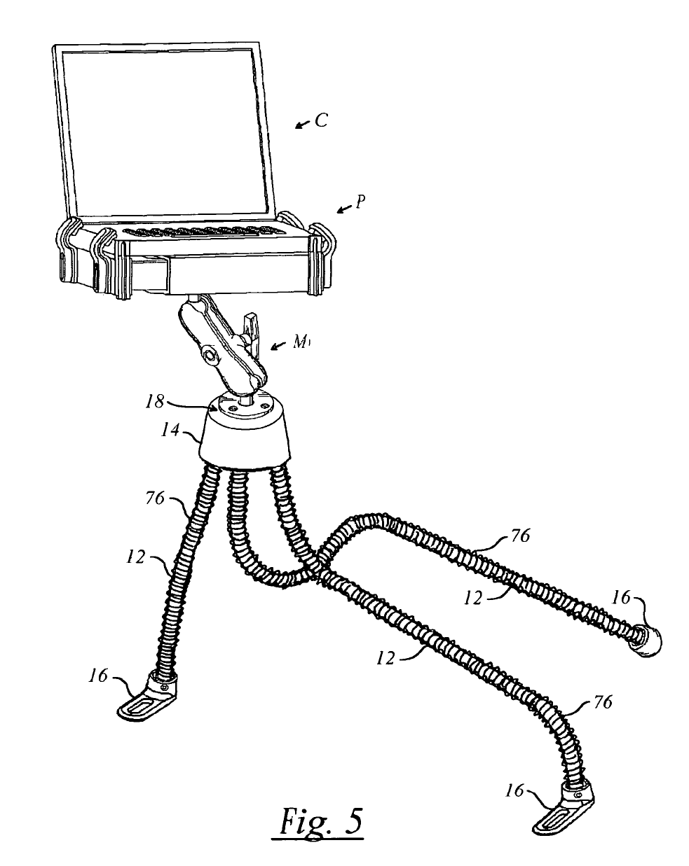

FIG. 5 illustrates the mounting bracket apparatus 10 of the invention with one of the shoes 16 (shown top right) embodied as another structure configured for resisting slipping relative to the external surface that is different from the shoes 16 shown in the earlier figures and shown here attached to the other two support rods 12 (left and bottom right). By example and without limitation, the shoe mechanism 16 (shown top right) is embodied as a plastic or rubber boot or cap of a type well-known in the art for use, for example, on cane tips, so that the support rod 12 can not slip relative to a floor or other external surface.

FIG. 5 also illustrates the permanently bendable metal support rods 12 each covered in a flexible plastic sheath 76 sized to slip over the outer diameter of the cylindrical metal support rods 12. According to one embodiment of the invention, the flexible plastic sheath 18 is a corrugated plastic tube, as shown in FIG. 5. Alternatively, the flexible plastic sheath 18 is one of an accordion configuration, a smooth-finished plastic tube, a thick foam tube, or another flexible plastic sheath that covers the metal rod 12 while permitting it to be bent to desired shapes without interference. Such alternative sheath materials are well-known to those of skill in the art so as not to require detailed descriptions.

Optionally, the respective apertures 30 formed in the ankle portions 28 of the shoes 16 are sized to accept and optionally to securely retain the elastically flexible plastic sheath 76 covering the metal support rod 12. As illustrated here and shown more clearly in FIG. 2, space is also optionally provided on the inside of the collar 46 between the bosses 72 and the collar rim 78 to tuck in the end of the plastic sheath 76. Optionally, the bosses 72 are sized such that the plastic sheath 76 is pinched between the support rod 12 and the inner wall surface 50 of the collar cavity 48 when the support rod 12 is secured within the pair of complementary part cylindrical relief grooves 52, 64 during assembly.

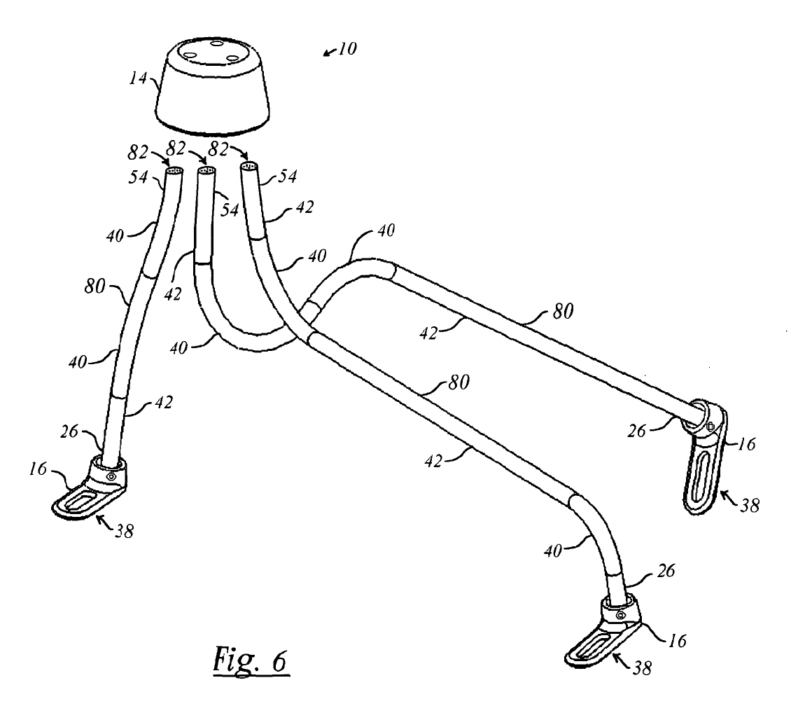

FIG. 6 illustrates the mounting bracket apparatus 10 of the invention having a plurality of bendable tubular metal support legs 80 filled with a solidified filler material and substituted for the permanently bendable metal support rods 12 shown in earlier embodiments. Accordingly, one or more of the permanently bendable metal support rods 12 is replaced with a bendable tubular metal support leg 80 formed of an elongated cylindrical tube with a substantially constant diameter of about ½ inch, but at least in the range of about ¼ inch or ⅜ inch to about 1 inch. The permanently bendable tubular metal support leg 80 formed of a bendable metal, such as aluminum or a bendable aluminum alloy, or another bendable metal. The support leg 80 is alternatively realized in steel, copper, permanently bendable copper alloys or another permanently bendable metal or rigid plastic material without limiting the practice of the invention.

According to one embodiment of the present invention, each of the one or more permanently bendable tubular metal support legs 80 includes the short lengthwise end portion 26 opposite from the combination clamp and mounting platform 14, each of which is fitted with one of the shoes 16 that are structured with means for securing the respective rod end portion 26 relative to an external surface. Alternatively, the shoe 16 is welded, soldered or brazed to the rod end portion 26. Each of the tubular support legs 80 is bendable by hand to orient the sole 38 of the shoe 16 into substantially parallel alignment with the external surface for more securely fixing the shoe 16 thereto. By example and without limitation, the bendable tubular support legs 80 are illustrated as having the different bent and substantially straight portions 40, 42, respectively, spaced along its length. After permanent bending of the one or more tubular support legs 80 to a desired configuration, a solidifiable filler material 82 is flowed, pumped, injected or otherwise installed within the interior of each bent tubular support leg 80 using known methods to fill substantially the entire length of the interior lengthwise tubular cavity, including the different bent and substantially straight portions 40, 42 and the short lengthwise end portions 26 and 54.

The solidifiable filler material 82 is of a type that is flowable in a first state and rigidly solidified or “hardened” in a second state that occurs at a later time. The solidifiable filler material 82 is, by example and without limitation, any air-curable epoxy resin that is flowable liquid in a first state and solidifies into a rigid solid structure in a second state. Alternatively, the solidifiable filler material 82 is, by example and without limitation, another material that is flowable in a first state and rigidly solid in a second state that occurs at a later time, such as a latex or a gypsum-based material, such as plaster of Paris, gypsum plaster, or Portland cement. According to another alternative embodiment of the present invention, the solidifiable filler material 82 is a plastic material which is a high-polymeric substance, including both natural and synthetic products, that is capable of flowing, possibly under applied heat and pressure, into the bent tubular support leg 80 and substantially filling the entire interior lengthwise tubular cavity and forming itself to the bent configuration of the bent tubular support leg 80 before solidifying into a relatively rigid solid having the shape of the interior lengthwise tubular cavity. For example, the solidifiable filler material 82 is a plastic of the thermoplastic family that includes styrene polymers and copolymers; acrylics such as acrylic resin or acrylonitrile-based materials; cellulosics; polyethylenes; polypropylene; nylons and vinyls such as Polyvinyl Chloride (PVC) or CPVC. See, e.g., Plastics Engineering Handbook of The Society of the Plastics Industry, Inc., edited by Michael L. Berins, 1991.

According to another example, the solidifiable filler material 82 is a plastic of the thermosetting family that includes aminos, i.e., melamine and urea, polyesters, alkyds, epoxies, and phenolics. See, e.g., Plastics Engineering Handbook of The Society of the Plastics Industry, Inc., edited by Michael L. Berins, 1991.

The solidifiable filler material 82 is optionally an injection-molded pigmented or unpigmented High Density Polyethylene (HDPE) plastic.

Accordingly, the solidifiable filler material 82 is pourable, injectable or otherwise installable into the interior lengthwise tubular cavity of the previously bent tubular support legs 80 through an opening in either of the short lengthwise end portions 26 and 54, as indicated by the arrow. When the solidifiable filler material 82 is cured or otherwise solidified, it provides an extremely rigid support structure within each tubular leg 80. Even solidifiable filler materials that remain relatively flexible in their solidified state are useful for practicing the present invention because the material substantially fills the interior cavity which prevents the outer tubular sleeve, i.e., the support leg 80, from collapsing. Several different rigidly solidifiable filler materials 82 and relatively flexibly solidifiable filler materials 82 are known and commercially available. Some examples are given but it will be understood that the listed materials are only examples and other solidifiable filler materials 82, both known and unknown, may be substituted. Accordingly, without limitation one example of a suitable rigidly solidifiable filler material 82 is disclosed by Cole, et al. in U.S. Pat. No. 4,072,194, “PUMPABLE EPOXY RESIN COMPOSITION,” the complete disclosure of which is incorporated herein by reference and which teaches an epoxy resin composition curable to a hard impermeable solid, and which may be available from Halliburton Company of Duncan, OK. Another example of a suitable rigidly solidifiable filler material 82 is disclosed by Riew, et al. in U.S. Pat. No. 4,107,116, “EPOXY RESIN PLASTiCS,” the complete disclosure of which is incorporated herein by reference and which teaches a hard and strong epoxy resin products of high impact resistance, and which may be available from The B. F. Goodrich Company of Akron, Ohio. Yet another example of a suitable rigidly solidifiable filler material 82 is disclosed by Schimmel, et al. in U.S. Pat. No. 4,126,596, “TWO PACKAGE POLYMERIC EPOXY COMPOSITIONS HAVING IMPROVED POTLIFE,” the complete disclosure of which is incorporated herein by reference and which teaches a two-package polymeric compositions which form a cured, hard, stain and solvent resistant material, and which may be available from PPG Industries, Inc. of Pittsburgh, Pa. It will be understood that the above rigidly and relatively flexibly solidifiable filler materials are given by example and without limitation as commercial products that are believed to have characteristics that make them suitable for use as the solidifiable filler material 82. However, other materials, both known and unknown, may be suitable substitutes therefore, the suitable solidifiable filler material 82 having the characteristics of being in a first state flowable, pumpable, injectable or otherwise installable within the elongated tubular interior cavity of the bent tubular support leg 80 using known methods for filling substantially the entire length of the interior, including the different bent and substantially straight portions 40, 42 and the short lengthwise end portions 26 and 54, and being in a second state that occurs at a relatively later time after the first state a rigidly or relatively flexibly solidified material filling substantially the entire length of the interior, including the different bent and substantially straight portions 40, 42 and the short lengthwise end portions 26 and 54 of the bent tubular support leg 80. Adhesion is an optional useful characteristic of the solidifiable filler material 82, whereby the solidified filler material 82 adheres to the interior wall surfaces of the bent tubular support leg 80.

When the solidifiable filler material 82 is a material such as epoxy resin, a gypsum-based material, a thermoplastic or thermosetting plastic, or a pigmented or unpigmented High Density Polyethylene (HDPE) plastic that, in its second solid state, is hardenable to a rigidly solid structure, the hardenable filler material 82 reinforces the tubular support legs 80 resists collapse thereof by means of its rigidity. On the other hand, solidifiable filler materials 82 such as latex, rubber, and room temperature vulcanizing silicone rubber (RTV) solidify into flexible materials that may flow with bending of the tubular support legs 80. Such flexible filler materials 82 reinforce the tubular support legs 80 by resisting collapse thereof. Additionally, such flexible filler materials 82 typically include the adhesive characteristic, whereby the material 82 adheres to the cavity wall which severely limits its ability to flow under load.

After installation and curing of the solidifiable filler material 82 within each of the previously configured tubular support legs 80, the combination clamp and mounting platform 14 is installed on the short lengthwise end portions 54, and the shoes 16 are installed on the short lengthwise end portion 26 opposite from the combination clamp and mounting platform 14. Thereafter, the configured tubular support legs 80 cannot be bent or otherwise reformed from their respective configurations because of the relative inflexibility and substantial incompressibility of the cured or otherwise solidified filler material 82 being contained within the tubular leg 80 and being restrained from flowing relative thereto. The mounting bracket apparatus 10 is thus permanently configured without any reasonable possibility of being bent or deformed under expected loads since such bending or deformation requires compression, flow, and shattering or flexing of the solidified filler material 82 and subsequent collapse of the tubular leg 80. As discussed herein, even when the filler material 82 is a relatively flexible solid it resists collapse of the tubular leg 80 and thus supports the leg 80 in its previously bent configuration. The resulting mounting bracket apparatus 10 can only be reconfigured by replacement of the one or more of the tubular support legs 80, either with another of the tubular support legs 80 or with one of the permanently bendable elongated cylindrical solid metal support rods 12. Accordingly, the mounting bracket apparatus 10 of the present invention optionally includes one or more of the permanently bendable elongated cylindrical solid metal support rods 12 substituted for one or more of the plurality of filled bendable tubular support legs 80.

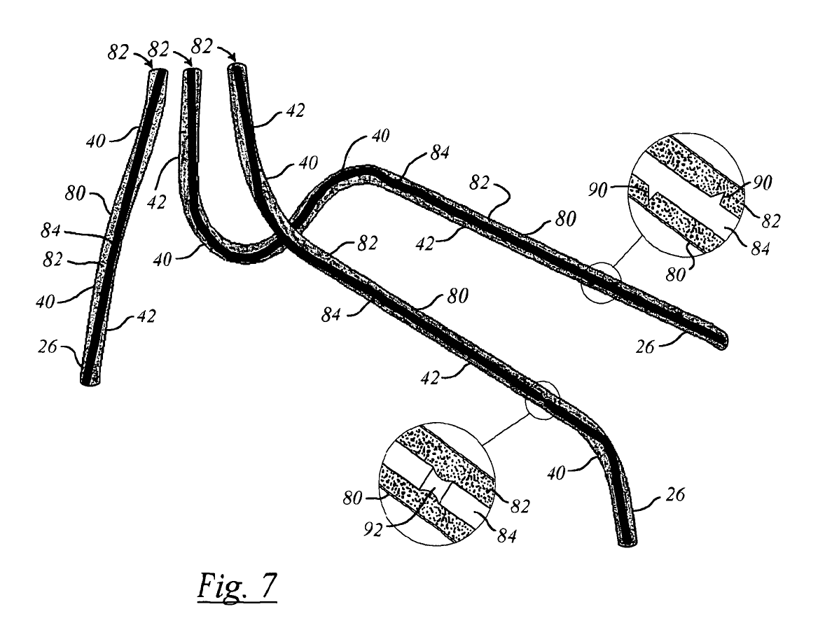

FIG. 7 illustrates the mounting bracket apparatus of the invention having the plurality of bendable tubular support legs 80 partially filled with a solidified filler material 82 being further internally reinforced with permanently bendable internal reinforcing stiffeners 84 embodied as permanently bendable elongated stiffener rods. The permanently bendable stiffener rods 84 operate as reinforcement bars, similar to “re-bar” in concrete, to further stiffen the structure and ensure integrity should the solidified material 82 flow or crack under load. By example and without limitation, the permanently bendable stiffener rods 84 are embodied as permanently bendable metal support rods formed, for example, of a permanently bendable aluminum or aluminum alloy with a substantially constant diameter or other cross-sectional dimension of about ¼ inch, but at least in the range of about ⅛ inch to about ⅜ inch or even ½ inch. The permanently bendable stiffener rods 84 are alternatively realized in steel, copper, permanently bendable copper alloys or another permanently bendable metal or rigid plastic material and may be flat, round, square, hexagonal or another cross-sectional shape without limiting the practice of the invention.

In FIG. 7 the plurality of solidly filled bendable tubular support legs 80 are illustrated in cross-section taken lengthwise along the longitudinal axes of the tubular support legs 80, whereby the solidified filler material 82 and stiffener rods 84 are exposed. As illustrated, the stiffener rods 84 are permanently bent into configurations that generally reflect the bent configurations of the corresponding tubular support legs 80. The stiffener rods 84 are expected to be inserted into the corresponding tubular support legs 80 prior to bending and are bent concurrently with the tubular support legs 80. The resulting bent portions 86 in the stiffener rods 84 generally mimic the corresponding bent portions 40 of the tubular support legs 80, and the remaining straight portions 88 generally correspond to the different straight portions 42. When the bends are minimal such that the bent portions 40 and straight portions 42 are substantially aligned, as shown for the far left short tubular support leg 80 in FIG. 7, the bent portions 86 are minimized or completely eliminated so that the stiffener rod 84 is substantially straight for its entire length, i.e., a single substantially straight portion 88, and the stiffener rod 84 can be inserted after the tubular support leg 80 is configured.

After the stiffener rods 84 are inserted into the respective tubular support legs 80 and the support legs and stiffener rods 80, 84 are bent, or after the straight or slightly bent stiffener rod 84 is inserted into the previously bent tubular support leg 80 (as shown at the far left of FIG. 7), a sufficient quantity of the solidifiable filler material 82 is flowed, pumped, injected or otherwise provided within the interior cavity of each bent tubular support leg 80 using known methods to fill substantially the entire length of the interior cavity, including the different bent and substantially straight portions 40, 42 and the short lengthwise end portions 26 and 54. As discussed herein, adhesion is an optional useful characteristic of the solidifiable filler material 82, whereby the solidifiable filler material 82 adheres the bent stiffener rod 84 to the interior cavity wall surfaces of the respective bent tubular support legs 80.

As discussed herein, after installation and solidifying of the solidifiable filler material 82 within the interior cavity of each of the bent tubular support legs 80, the combination clamp and mounting platform 14 is installed on the short lengthwise end portions 54, and the shoes 16 are installed on the short lengthwise end portion 26 opposite from the combination clamp and mounting platform 14. Thereafter, the tubular support legs 80 cannot be bent, collapsed or otherwise reformed from their respective configurations because of the incompressibility and rigidity of the solidified filler material 82 operating in combination with the stiffness of the interior stiffener rod 84. Accordingly, the mounting bracket apparatus 10 is permanently configured without any reasonable possibility of being bent or deformed or otherwise failing under expected loads since such bending or deformation requires flowing or shattering and collapse of solidified filler material 82 and concurrent bending of both the tubular support legs 80 and the rigid interior stiffener rods 84. One or more barbs 90 or necked-down portions 92 are optionally formed one or more of the interior stiffener rods 84. Alternatively, the interior stiffener rods 84 are provided with a rough surface finish that promotes adhesion of the solidifiable filler material 82. The barbs 90, necked-down portions 92 and/or surface finish increase mechanical coupling, i.e., gripping, between the interior stiffener rods 84 and the solidifiable filler material 82, which interlocks the interior stiffener rods 84 with the bent tubular support legs 80 and further limits the flowability of the solidified filler material 82 which thereby increases the overall stiffness of the support legs 80. The mounting bracket apparatus 10 can only be reconfigured by replacement of the one or more of the tubular support legs 80, either with another of the tubular support legs 80 or with one of the permanently bendable elongated cylindrical solid metal support rods 12. Accordingly, the mounting bracket apparatus 10 of the present invention optionally includes one or more of the permanently bendable elongated cylindrical solid metal support rods 12 substituted for one or more of the plurality of solidly filled bendable tubular support legs 80.

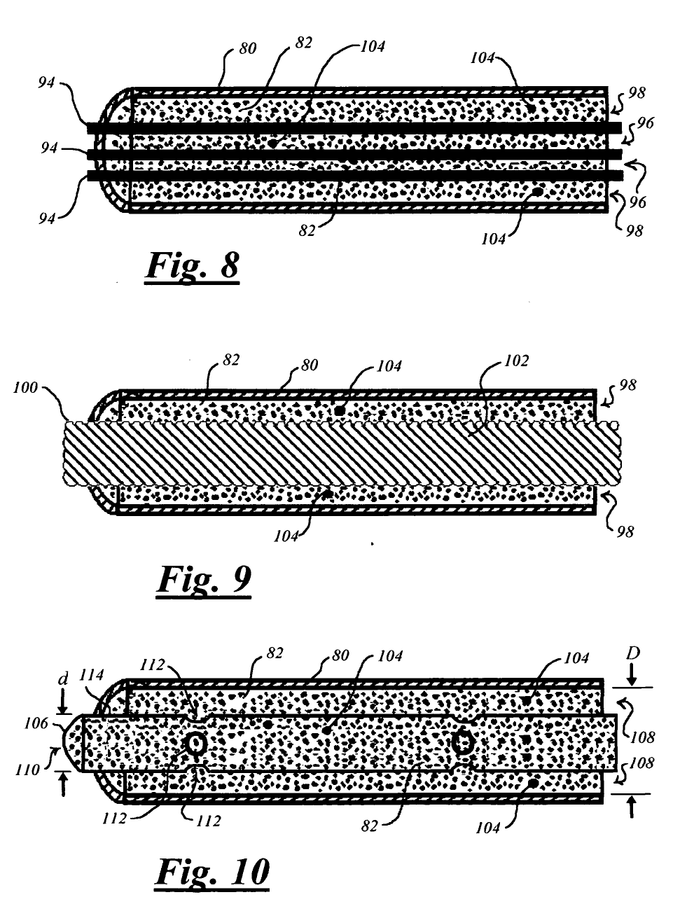

FIG. 8 illustrates one alternative embodiment of the present invention having an alternative permanently bendable interior reinforcing stiffener 94 formed of a plurality of relatively smaller or lighter gage, i.e., thinner, permanently bendable interior support wires that are substituted for one or more of the permanently bendable interior stiffener rods 84 illustrated in FIG. 7. By example and without limitation, the plurality of permanently bendable interior reinforcing support wires 94 are formed, for example, of a permanently bendable aluminum or aluminum alloy having a substantially constant diameter of about 1/16 inch, but at least in the range of about 1/32 inch to about ⅛ inch diameter or other cross-sectional dimension. The permanently bendable support wires 94 are alternatively realized in steel, copper, permanently bendable copper alloys or another permanently bendable metal or rigid plastic material and may be flat, round, square, hexagonal or another cross-sectional shape without limiting the practice of the invention. The plurality of permanently bendable interior reinforcing support wires 94 are expected to be sufficiently flexible as to permit insertion after the tubular support leg 80 is configured. However, reinforcing wires 94 formed of larger diameters of stiffer materials are optionally inserted before configuring of the respective tubular support legs 80 and are configured concurrently therewith.

After the interior reinforcing support wires 94 are inserted into the respective tubular support legs 80 and after the support legs 80 and interior support wires 94 are bent, a sufficient quantity of the solidifiable filler material 82 is flowed, pumped, injected or otherwise installed within the interior of each bent tubular support leg 80 using known methods to fill substantially the entire length of the interior cavity, including the different bent and substantially straight portions 40, 42 and the short lengthwise end portions 26 and 54. The solidifiable filler material 82 fills spaces 96 between the different interior support wires 94 as well as spaces 98 between the different interior support wires 94 and the interior cavity wall surfaces of the respective bent tubular support legs 80. The plurality of permanently bendable interior reinforcing support wires 94 operate to further reinforce and stiffen the structure and ensure integrity should the solidified filler material 82 flow or crack under load.

As discussed herein, adhesion is an optional useful characteristic of the solidifiable filler material 82, whereby the solidifiable filler material 82 adheres the bent interior reinforcing support wires 94 to one another and to the interior wall surfaces of the interior cavity of the respective bent tubular support legs 80.

FIG. 9 illustrates another alternative embodiment of the present invention having another alternative permanently bendable interior reinforcing stiffener 100 formed of a twisted cable that is substituted for one or more of the permanently bendable interior reinforcing stiffener rods 84 illustrated in FIG. 7. The twisted cable 100 is, by example and without limitation, a commercially available twisted cable formed of plurality of relatively lighter gage, i.e., thinner, permanently bendable interior support wires 102 twisted about a central longitudinal axis into a single cable or “wire rope” of a type that is generally well known. By example and without limitation, the twisted cable 100 is formed of light gage, i.e., thin, steel wire strands 102 twisted together to form a stiff but bendable wire rope.

By example and without limitation, the plurality of thin permanently bendable interior support wires 102 are alternatively realized in a permanently bendable aluminum or aluminum alloy, copper, a permanently bendable copper alloy, or another permanently bendable metal or rigid plastic material without limiting the practice of the invention. The twisted cable 100 is expected to be sufficiently flexible as to permit insertion after the tubular support leg 80 is configured. However, twisted cables 100 formed of larger diameters of stiffer materials are optionally inserted before configuring of the respective tubular support legs 80 and are configured concurrently therewith.

After the twisted cables 100 are inserted into the respective tubular support legs 80 and after the support legs 80 and twisted cables 100 are bent, a sufficient quantity of the solidifiable filler material 82 is flowed, pumped, injected or otherwise installed within the interior of each bent tubular support leg 80 using known methods to fill substantially the entire length of the interior cavity, including the different bent and substantially straight portions 40, 42 and the short lengthwise end portions 26 and 54. The solidifiable filler material 82 fills spaces 98 between the twisted cable 100 and the interior wall surfaces of the respective bent tubular support legs 80, as well as seeping between the individual wires 102 that comprise the cable 100. The twisted cables 100 operates to further reinforce and stiffen the structure and ensure integrity should the solidified filler material 82 flow or crack under load.

As discussed herein, adhesion is an optional useful characteristic of the solidifiable filler material 82, whereby the solidified filler material 82 adheres the bent twisted cables 100 to the interior cavity wall surfaces of the respective bent tubular support legs 80, as well adhering the individual cable wires 102 as to one another.

FIGS. 8 and 9 also illustrates another embodiment of the present invention wherein the solidifiable filler material 82 is filled and thereby reinforced with stiffener particles 104 mixed thereinto. Numerous stiffening filler particles 104 are well-known and commercially available for use in tailoring the properties of a liquid plastic or other solidifiable filler material prior to casting in the support legs 80. When used as filler, such stiffening particles 104 increase the viscosity of the liquid solidifiable filler material 82, i.e., a thickening agent, and also affect the properties of the solidified filler material 82. Density and strength are two properties that are increased by stiffening filler particles 104. Sand and gravel are stiffening filler particles 104 commonly added to cement. For plastic filler materials 82, the stiffening filler particles 104 may be powder filler particles, such as aluminum powder. Cab-o-sil is a well-known resin thickening (thixotropic) stiffening filler particle additive 104 for polyester or epoxy solidifiable filler materials 82 and some urethane solidifiable filler materials 82, especially for use as a urethane adhesive. Chopped strands of fiberglass in ¼″ or ½″ lengths are common stiffening filler particles 104 usually used to strengthen liquid polyester resin filler materials 82, but is also be used in urethane filler materials 82 in combination with Fillite to increase cured strength. Fiberglass flock is a stiffening filler particle 104 used to thicken a solidifiable liquid polyester filler material 82 to a paste-like consistency, and because fiberglass flock particles 104 are actually ground glass, they greatly increase the strength of the solidifiable filler materials 82. Fillite is a gray powder stiffening filler particle 104 added to solidifiable liquid urethane filler materials 82 as an inexpensive stiffening filler particle 104 that takes up volume so that less is used of a more expensive solidifiable liquid filler material 82. Because of its density, Fillite will neither float nor sink in a solidifiable liquid resin filler material 82. Cured castings of the solidifiable filler materials 82 can be achieved that will float in water if enough is added. Sil-Cell Microballoons are hollow silica spheres that behave similarly to Fillite as a stiffening filler particle 104, except that the particles have a higher tendency to float in low-viscosity solidifiable filler materials 82. Talc is an ultra-fine, bright white powder stiffening filler particle 104 that reduces shrinkage and improves smoothness, abrasion resistance and temperature resistance in solidifiable epoxy, urethane and polyester filler materials 82. Commercial liquid plasticizers are well-known stiffening filler particles 104 that, when added to epoxy, urethane or polyester, increase cured toughness, resiliency and flexibility of the solidified filler materials 82.

FIG. 10 illustrates another alternative embodiment of the present invention having a rigid metal reinforcing inner stiffener tube 106 that is substituted for one or more of the permanently bendable interior rod stiffeners 84 illustrated in FIG. 7. The inner stiffener tube 106 has an outer diameter d that is sized smaller than the inner diameter D of the tubular support leg 80 so that it fits inside with annular spaces 108 between the inner stiffener tube 106 and the interior cavity wall surfaces. The inner stiffener tube 106 is operated as reinforcement bars similarly to the permanently bendable stiffener rods 84 to further stiffen the structure and ensure integrity in the unlikely event the solidified material 82 fails. Accordingly, the inner stiffener tubes 106 are expected to be inserted into the corresponding tubular support legs 80 prior to bending and are bent concurrently with the tubular support legs 80. The resulting bent inner stiffener tubes 106 generally mimic the corresponding bent and straight portions 40, 42 of the tubular support legs 80. Alternatively, a straight or slightly bent inner stiffener tube 106 is inserted into the previously bent tubular support leg 80, as shown in FIG. 7 for the stiffener rod 84. Thereafter, a sufficient quantity of the solidifiable filler material 82 is flowed, pumped, injected or otherwise provided within the interior cavity of each bent tubular support leg 80 to substantially fill the annular space 108 between the inner stiffener tube 106 and the interior cavity wall surfaces. The inner stiffener tube 106 both reinforces the bent tubular support leg 80 and reduces the volume of the interior cavity that is filled with the solidifiable filler material 82 so that less is used of a more expensive solidifiable liquid filler material 82. When the solidifiable filler material 82 includes adhesive properties it adheres the bent inner stiffener tube 106 to the interior cavity wall surfaces of the respective bent tubular support legs 80.

According to one embodiment of the present invention, the a sufficient quantity of the solidifiable filler material 82 is flowed, pumped, injected or otherwise provided within the tubular interior cavity 110 of the inner stiffener tube 106.

According to another embodiment of the present invention, one or more holes or “windows” 112 are provided through the wall 114 of the inner stiffener tube 106. During filling the windows 112 permit the solidifiable liquid filler material 82 to freely flow between the inner tube's tubular interior cavity 110 and the annular space 108 between the inner stiffener tube 106 and the interior cavity wall surfaces of the outer tubular leg 80. The solidified filler material 82 in the windows 112 mechanically couples, i.e., interlocks, the inner stiffener tube 106 with the bent tubular support legs 80.

While the preferred embodiment of the invention has been illustrated and described, it will be appreciated that various changes can be made therein without departing from the spirit and scope of the invention. For example, materials may be substituted for the different components of the flexible support apparatus of the invention without departing from the spirit and scope of the invention. Therefore, the inventor makes the following claims.

1. A mounting bracket, comprising:
a plurality of permanently bendable tubular support legs each comprising a cavity extended between opposing first and second end portions;
filler means substantially filling the cavity of each permanently bendable tubular support leg for supporting the permanently bendable tubular support leg against collapse;
means for clamping the first end portions of the plurality of support legs in a fixed arrangement; and
means for securing the second end portions of the plurality of support legs relative to an external surface.

2. The mounting bracket of claim 1, further comprising means for fixing an external device to the clamping means.

3. The mounting bracket of claim 2 wherein the securing means further comprises means for permanently securing one or more of the second end portions of the plurality of support legs relative to an external surface.

4. The mounting bracket of claim 3 wherein the securing means further comprises means for resisting relative slipping of one or more of the second end portions of the plurality of support legs relative to an external surface.

5. The mounting bracket of claim 1 wherein the means for clamping the first end portions of the plurality of support legs in a fixed arrangement further comprises means for clamping each of the first end portions between an external collar and an internal wedge.

6. The mounting bracket of claim 5 wherein the means for clamping each of the first end portions between an external collar and an internal wedge further comprises clamping a lengthwise portion of each of the first end portions in a lengthwise cylindrical cavity.

7. The mounting bracket of claim 1, further comprising internal reinforcing means contained within one or more of the plurality of bendable tubular metal support legs.

8. The mounting bracket of claim 7 wherein the internal reinforcing means further comprises a stiffener selected from the group of stiffeners consisting of: a permanently bendable rod, a plurality of permanently bendable wires, a twisted cable, and an inner tube.

9. The mounting bracket of claim 7 wherein one or more of the reinforcing means further comprises means for interlocking the internal reinforcing means with the cavity of the respective tubular support leg.

10. The mounting bracket of claim I wherein the filler means further comprises a solidified liquid filler material.

11. The mounting bracket of claim 10 wherein the solidified liquid filler material further comprises a rigidly hardenable filler material.

12. The mounting bracket of claim 1, further comprising a flexible sheath substantially covering each of the plurality of permanently bendable support legs.

13. A vehicle mounting bracket, comprising:
a plurality of elongated permanently bendable tubular support legs each comprising a first end portion structured for being clamped, an opposite second end portion structured for being secured relative to an external surface, and an interior tubular cavity extending between the first and second end portions;
a solidified filler material substantially filling the interior tubular cavity;
a clamp mechanism structured for clamping the first end portions of the plurality of support legs in a fixed arrangement; and
a shoe mechanism coupled to the second end portions of one of the plurality of support legs, the shoe mechanism being structured for securing the respective second end portion relative to an external surface.

14. The mounting bracket of claim 13 wherein the clamp mechanism further comprises a female collar and a male wedge with one of the collar and the wedge being structured with a plurality of relief grooves each structured to accept the first end portion of one of the plurality of support legs.

15. The mounting bracket of claim 14, further comprising:
three of the elongated permanently bendable tubular support legs; and
wherein the clamp mechanism is further structured for clamping the first end portions of the plurality of tubular support legs in a fixed tripodal arrangement.

16. The mounting bracket of claim 13 wherein each of the elongated permanently bendable tubular support legs further comprises an elongated tube formed of a substantially rigid material selected from the group of substantially rigid materials consisting of: steel, copper, a permanently bendable copper alloy, aluminum, a permanently bendable aluminum alloy, and a permanently bendable hard plastic.

17. The mounting bracket of claim 13 wherein the solidified filler material further comprises one of: an air-curable epoxy resin, a latex, a gypsum-based material, a plastic, rubber and a room temperature vulcanizing silicone rubber.

18. The mounting bracket of claim 13, further comprising a plurality of stiffener particles embedded in the solidified filler material.

19. The mounting bracket of claim 13, further comprising an elongated stiffener within the interior tubular cavity and embedded in the solidified filler material.

20. The mounting bracket of claim 19 wherein the elongated stiffener further comprises one of: a permanently bendable metal rod, a plurality of permanently bendable metal wires, a cable formed of a plurality of twisted metal wires, a tube having an outer diameter that is smaller than an inner diameter of the interior tubular cavity.

21. The mounting bracket of claim 15 wherein the clamp mechanism further comprises an external collar and mating wedge with a plurality of part cylindrical reliefs formed therebetween, the part cylindrical reliefs being sized for clamping the first end portions of the plurality of tubular support legs.

22. A vehicle mounting bracket, comprising:
a plurality of permanently bendable tubular support legs each having first and second lengthwise end portions at opposite ends thereof and a tubular interior cavity therebetween;
a solidified filler material substantially filling the tubular interior cavity of one or more of the plurality of permanently bendable tubular support legs;
a clamp for joining the plurality of tubular support legs in a relatively fixed arrangement, the clamp comprising:
an outer female collar forming therein a cavity having at intervals around an inside wall surface thereof a plurality of relief grooves that are sized for nesting of the first lengthwise end portion of one of the tubular support legs, one of the plurality of relief grooves being formed for each of the plurality of tubular support legs,
an inner male wedge having at intervals around an outside wall surface thereof a plurality of relief grooves that are sized for nesting of the lengthwise end portion of one of the tubular support legs, one of the relief grooves being formed in a complementary configuration with a corresponding one of the relief grooves formed on the collar inside wall surface for forming a plurality of pairs of complementary relief grooves with one of the pairs being provided for each of the plurality of tubular support legs, each of the plurality of pairs of complementary relief grooves partly enclosing a lengthwise space that is smaller than the respective plurality of tubular support leg end portion; and
means for urging the male wedge into the outer female collar with each of the tubular support leg lengthwise end portions securely captured the lengthwise space partly enclosed by one of the pairs of complementary relief grooves.

23. The mounting bracket of claim 22, further comprising a shoe coupled to the second lengthwise end portion of one or more of the plurality of tubular support legs, the shoe being structured with means for securing the respective second end portion relative to an external surface.

24. The mounting bracket of claim 23 wherein the shoe further comprises one of: a shoe structured for being permanently fixed to an external surface with a mechanical fastener, and a shoe structured for resisting slipping relative to an external surface.

25. The mounting bracket of claim 22 wherein at least one of the tubular support legs is different in length than at least on other of the tubular support legs.

26. The mounting bracket of claim 22 wherein the plurality of permanently bendable tubular support legs each further comprises a permanently bendable metal tube.

27. The mounting bracket of claim 26, further comprising crosswise reinforcement within the tubular interior cavity of the one or more of the plurality of permanently bendable tubular support legs that is substantially filled with the solid filler material, the crosswise reinforcement being substantially embedded in the solidified filler material.

28. The mounting bracket of claim 27 wherein the crosswise reinforcement further comprises one of a permanently bendable metal rod, a plurality of permanently bendable metal wires, a cable formed of a plurality of twisted metal wires, and a rigid tube sized to fit inside the tubular interior cavity.

29. The mounting bracket of claim 28 wherein the crosswise reinforcement further comprises means for mechanical coupling with the solidified filler material.

30. The mounting bracket of claim 28 wherein the solidified filler material further comprises an adhesive material.

31. A method for manufacturing a vehicle mounting bracket, the method comprising:
of a permanently bendable tubular material, sizing a length of each of a plurality of elongated tubular members each having first and second end portions with a tubular interior cavity therebetween;
shaping one or more of the plurality of elongated tubular members into a configuration useful for operating in concert with others of the plurality of elongated tubular members for supporting a rigid mounting platform at the colocated first ends of the plurality of elongated tubular members;
substantially filling the tubular interior cavity of one or more of the plurality of elongated tubular members with a solidifiable liquid filler material;
substantially colocating the first ends of the plurality of elongated tubular members;
relatively fixing the colocated first ends of the plurality of elongated tubular members; and
supporting a rigid mounting platform at the colocated first ends of the plurality of elongated tubular members.

32. The method of claim 31 wherein sizing a length of each of a plurality of elongated tubular members further comprises sizing at least one of the elongated tubular members a different length than at least one other elongated tubular member.

33. The method of claim 31 wherein sizing a length of each of a plurality of elongated tubular members further comprises sizing at least three elongated tubular members.

34. The method of claim 31 wherein substantially filling the tubular interior cavity of one or more of the plurality of elongated tubular members with a solidifiable liquid filler material further comprises substantially filling the tubular interior cavity with a solidifiable liquid filler material selected from the group of solidifiable liquid filler materials consisting of: a hardenable epoxy, a latex, a gypsum-based material, a plastic, a rubber, and a room temperature vulcanizing silicone rubber.

35. The method of claim 31, further comprising reinforcing the solidifiable liquid filler material with a plurality of stiffener particles mixed thereinto.

36. The method of claim 31, further comprising internally reinforcing one or more of the plurality of elongated tubular members by installing an elongated stiffener of a permanently bendable material within the tubular interior cavity thereof.

37. The method of claim 36 wherein substantially filling the tubular interior cavity of one or more of the plurality of elongated tubular members with a solidifiable liquid filler material further comprises embedding the elongated stiffener in the filler material.

38. The method of claim 31, further comprising installing a means for securing the second end portions of the elongated tubular members relative to an external surface.
